(19) United States
(12) Patent Application Publication
(10) Pub. No.: US 2026/0119991 A1
(43) Pub. Date: Apr. 30, 2026

(54) MULTIMODAL QUANTUM FEDERATED LEARNING SYSTEM FOR SATELLITES AND SATELLITE ATTITUDE CONTROL METHOD USING THE SAME

(71) Applicant: University-Industry Cooperation Group of Kyung Hee University, Gyeonggi-do (KR)

(72) Inventors: CHOONG SEON HONG, Gyeonggi-do (KR); YU MIN PARK, Gyeonggi-do (KR)

(21) Appl. No.: 19/370,951

(22) Filed: Oct. 28, 2025

(30) Foreign Application Priority Data
Oct. 29, 2024 (KR) 10-2024-0150187

(51) Int. Cl. G06N 20/00

(52) U.S. Cl. CPC G06N 20/00

(57) ABSTRACT

A multimodal quantum federated learning system for satellites includes satellites and a central server configured to communicate with the satellites. The satellites include two or more of a bit-based satellite, a quantum-based satellite, and a hybrid satellite. The central server trains initial models including a bit-based network model and a quantum-based network model using training data, distributes the bit-based network model among the trained initial models to each of the bit-based satellite and the hybrid satellite, and distributes the quantum-based network model among the trained initial models to each of the quantum-based satellite and the hybrid satellite.

### CROSS-REFERENCE TO RELATED APPLICATION AND CLAIM OF PRIORITY

This application claims the benefit under 35 USC § 119(a) of Korean Patent Application No. 10-2024-0150187, filed on Oct. 29, 2024, in the Korean Intellectual Property Office, the entire disclosure of which is incorporated herein by reference for all purposes.

### BACKGROUND

### 1. Field

The present disclosure relates to a multimodal quantum federated learning system for satellites and a satellite attitude control method using the same.

### 2. Description of Related Art

Federated learning is a machine learning technology in which a plurality of terminals and a single server collaborate to train a global model. Here, the terminal may be, for example, an Internet-of-Things device, a smartphone, or the like. This federated learning has an advantage of being able to overcome a shortage of training samples for training with a limited amount of local data.

Meanwhile, on-board model learning in satellites is required for purposes such as limited data transmission, real-time data processing, security, and the like, but it has limitations in conventional deep learning model training under the current computing-constrained environments of satellites. An example of an on-board model loaded onto a satellite is a model installed on the satellite to perform artificial intelligence-based object detection on an image of an object (e.g., an airplane) captured by a satellite optical camera.

In addition, existing satellite attitude control systems are optimized only for specific missions, and thus have a disadvantage in that they may not perform various missions at the same time. That is, when a satellite's attitude control is switched according to a change in mission, the firmware needs to be directly updated through a ground base station, but the communication delay or overhead that occurs at this time poses a risk of causing major problems in performing the satellite mission.

In addition, there is still no data preprocessing algorithm capable of effectively performing, in the satellite, resource-constrained fusion processing of multimodal data generated in the satellite, and since an unstable communication environment including sensor errors caused by solar wind exists, a cooperative learning system between satellites that may use autonomously collected data for training is required.

Examples of the related art include Korean Patent Laid-Open Publication No. 10-2023-0051110 and Korean Patent Laid-Open Publication No. 10-2020-0097787.

### SUMMARY

The disclosed embodiment is intended to provide a technique for training and managing an artificial intelligence model for attitude control in line with mission execution of a microsatellite.

The disclosed embodiment is intended to provide a multimodal quantum federated learning system for satellites to which quantum federated learning technology is applied and a satellite attitude control method using the same.

In one general aspect, there is provided a learning system including satellites and a central server configured to communicate with the satellites, in which wherein the satellites include two or more of a bit-based satellite, a quantum-based satellite, and a hybrid satellite, and the central server trains initial models including a bit-based network model and a quantum-based network model using training data, distributes the bit-based network model among the trained initial models to each of the bit-based satellite and the hybrid satellite, and distributes the quantum-based network model among the trained initial models to each of the quantum-based satellite and the hybrid satellite.

The training data may be multimodal data acquired from the satellites, and the central server may train the initial models such that the bit-based network model of the initial models receives the training data as input and outputs a preprocessing result feature, and the preprocessing result feature and a preset mission signal are input into the quantum-based network model of the initial models to output a satellite attitude control result.

The central server may train the initial model such that the training data is input into the initial model to output a satellite attitude control result, the training data is input into a numerical optimization module to output a reference value for the satellite attitude control result, and a difference between the satellite attitude control result of the initial model and the reference value of the numerical optimization module is minimized.

The bit-based satellite and the hybrid satellite may each locally train the distributed bit-based network model and transmit parameters of the locally trained bit-based network model to the central server, and the central server may update parameters of the bit-based network model of the initial models by averaging the parameters of the locally trained bit-based network model.

The quantum-based satellite and the hybrid satellite may each locally train the distributed quantum-based network model and transmit parameters of the locally trained quantum-based network model to the central server, and the central server may update parameters of the quantum-based network model of the initial models by averaging the parameters of the locally trained quantum-based network model.

The bit-based satellite may input multimodal data generated in the bit-based satellite into the distributed bit-based network model to extract a preprocessing result feature, transmit the extracted preprocessing result feature from the bit-based satellite to an adjacent quantum-based satellite or hybrid satellite, and receive a satellite attitude control result from the adjacent quantum-based satellite or hybrid satellite to perform satellite attitude control.

The quantum-based satellite may receive a preprocessing result feature from an adjacent bit-based satellite, input the received preprocessing result feature into the distributed quantum-based network model to output a satellite attitude control result, and transmit the satellite attitude control result to the adjacent bit-based satellite.

The quantum-based satellite may transmit multimodal data generated in the quantum-based satellite from the quantum-based satellite to an adjacent bit-based satellite or hybrid satellite, receive a preprocessing result feature for the multimodal data from the adjacent bit-based satellite or hybrid satellite, input the received preprocessing result feature into the distributed quantum-based network model to output a satellite attitude control result, and perform satellite attitude control based on the output satellite attitude control result.

The hybrid satellite may input multimodal data generated in the hybrid satellite into the distributed bit-based network model to extract a preprocessing result feature, input the extracted preprocessing result feature into the distributed quantum-based network model to output a satellite attitude control result, and perform satellite attitude control based on the output satellite attitude control result.

In another general aspect, there is provided a method performed in a satellite having one or more processors and a memory storing one or more programs executed by the one or more processors, including receiving a pre-trained bit-based network model distributed from a central server, inputting multimodal data generated in the satellite into the distributed bit-based network model to extract a preprocessing result feature, transmitting the extracted preprocessing result feature from the satellite to an adjacent quantum-based satellite or hybrid satellite, and receiving a satellite attitude control result from the adjacent quantum-based satellite or hybrid satellite and performing satellite attitude control.

The multimodal data may include image data, vibration data, status data, and sensing data, and the extracting of the preprocessing result feature may include inputting the image data into an image encoder to generate a first image embedding, inputting the vibration data into an image converter to convert the vibration data into an image format, and inputting the vibration data in the image format into an image encoder to generate a second image embedding, inputting the status data into a vector encoder to generate a first vector embedding, inputting the sensing data into the vector encoder to generate a second vector embedding, inputting the first image embedding, the second image embedding, the first vector embedding, and the second vector embedding into a multimodal multi-head attention module to transform the first image embedding, the second image embedding, the first vector embedding, and the second vector embedding into one representative vector, inputting the representative vector into an attentive embedding layer to generate a semantic emphasis embedding vector, and inputting the semantic emphasis embedding vector into a multi-head activation function-based hidden layer to extract the preprocessing result feature.

In still another general aspect, there is provided a method performed in a satellite having one or more processors and a memory storing one or more programs executed by the one or more processors, including receiving a pre-trained quantum-based network model distributed from a central server, transmitting multimodal data generated in the satellite to a bit-based satellite or a hybrid satellite adjacent to the satellite, receiving a preprocessing result feature for the multimodal data from the adjacent bit-based satellite or hybrid satellite, and inputting the preprocessing result feature into the distributed quantum-based network model to output a satellite attitude control result, and performing satellite attitude control based on the output satellite attitude control result.

### BRIEF DESCRIPTION OF THE DRAWINGS

FIG. 1 is a schematic diagram illustrating a federated learning system between satellites and a central server according to an embodiment of the present disclosure.

FIG. 2 is a diagram illustrating a network model between heterogeneous satellites in a federated learning system according to an embodiment of the present disclosure.

FIG. 3 is a diagram specifically illustrating a state of performing knowledge collaboration in the network model between heterogeneous satellites in an embodiment of the present disclosure.

FIG. 4 is a diagram schematically illustrating a process of preprocessing multimodal data in a bit-based satellite according to an embodiment of the present disclosure.

FIG. 5 is a diagram illustrating a state in which an initial model is generated in a central server according to an embodiment of the present disclosure.

FIG. 6 is a diagram briefly illustrating a process of performing satellite attitude control through knowledge cooperation between heterogeneous satellites in an embodiment of the present disclosure.

FIG. 7 is a flowchart specifically illustrating a process of performing satellite attitude control through knowledge cooperation between heterogeneous satellites in an embodiment of the present disclosure.

FIG. 8 is a flowchart for describing a process of training an initial model in an embodiment of the present disclosure.

FIG. 9 is a diagram illustrating a state in which federated learning between each satellite and a central server is performed in an embodiment of the present disclosure.

FIG. 10 is a diagram illustrating a state in which local learning is performed through knowledge collaboration between heterogeneous satellites in an embodiment of the present disclosure.

FIG. 11 is a block diagram exemplarily illustrating a computing environment that includes a computing device suitable for use in exemplary embodiments.

### DETAILED DESCRIPTION

Hereinafter, specific embodiments of the present disclosure will be described with reference to the accompanying drawings. The following detailed description is provided to assist in a comprehensive understanding of the methods, devices and/or systems described herein. However, the detailed description is only for illustrative purposes and the present disclosure is not limited thereto.

In describing the embodiments of the present disclosure, when it is determined that detailed descriptions of known technology related to the present disclosure may unnecessarily obscure the gist of the present disclosure, the detailed descriptions thereof will be omitted. The terms used below are defined in consideration of functions in the present disclosure, but may be changed depending on the customary practice, the intention of a user or operator, or the like. Thus, the definitions should be determined based on the overall content of the present specification. The terms used in the detailed description are only for describing the embodiments of the present disclosure, and should not be construed as limitative. Unless expressly used otherwise, a singular form includes a plural form. In the present description, the terms “including”, “comprising”, or the like are used to indicate certain characteristics, numbers, steps, operations, elements, and a portion or combination thereof, but should not be interpreted to preclude one or more other characteristics, numbers, steps, operations, elements, and a portion or combination thereof.

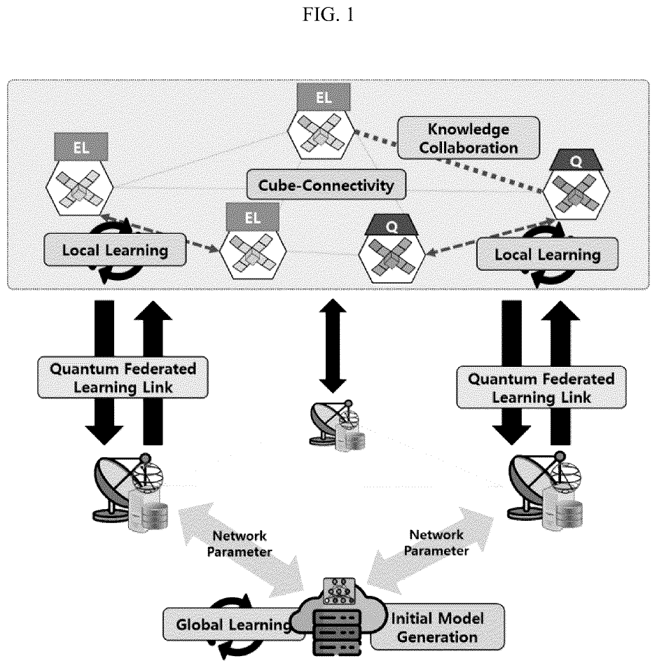

FIG. 1 is a schematic diagram illustrating a federated learning system between satellites and a central server according to an embodiment of the present disclosure.

Referring to FIG. 1, an initial network model (an artificial intelligence-based neural network model, hereinafter referred to as an “initial model”) is generated in a global server on the ground (which may be referred to as a central server), and the initial model is distributed to each satellite via a ground-satellite communication link. The initial model loads a quantum model or a deep learning model onto a quantum-based computing system or a bit-based computing system, respectively, in line with the satellite's specifications. In an embodiment, the satellite may be a cube satellite, but is not limited thereto.

The satellites may be divided into a bit-based satellite and a quantum-based satellite. That is, the bit-based satellite includes a bit-based computing system, and a deep learning model may be loaded as an initial model. The quantum-based satellite includes a quantum-based computing system, and may be equipped with a quantum model as an initial model. During a learning or reasoning process, nearby bit-based and quantum-based satellites exchange information with each other and perform knowledge collaboration.

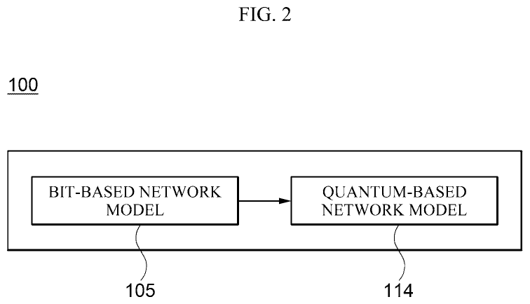

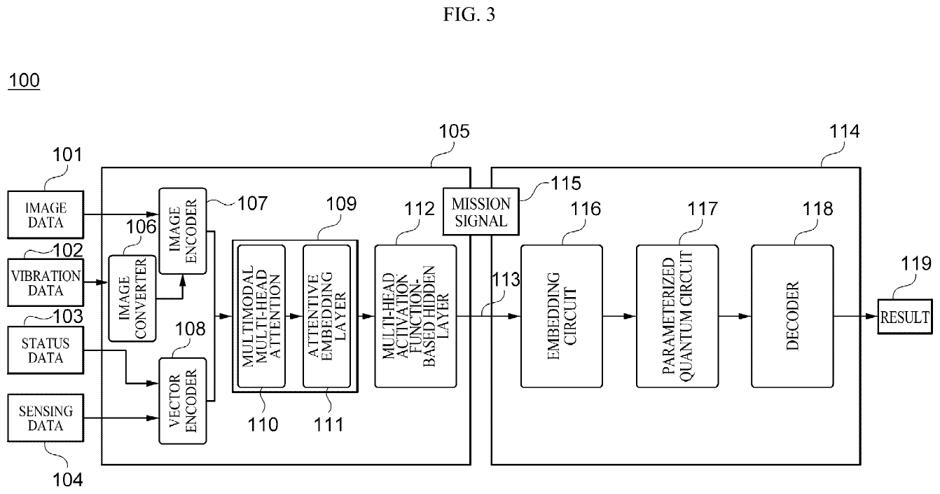

FIG. 2 is a diagram illustrating a network model between heterogeneous satellites in a federated learning system according to an embodiment of the present disclosure, and FIG. 3 is a diagram specifically illustrating a state of performing knowledge collaboration in the network model between heterogeneous satellites in an embodiment of the present disclosure.

Referring to FIGS. 2 and 3, a quantum-federated learning system 100 may include a bit-based network model 105 and a quantum-based network model 114. Here, the bit-based network model 105 may be loaded onto the bit-based satellite, and the quantum-based network model 114 may be mounted on the quantum-based satellite.

The bit-based satellite may preprocess multimodal data collected from the corresponding satellite through the bit-based network model 105 and transmit a preprocessing result to a nearby quantum-based satellite. Then, the quantum-based satellite may estimate a result for satellite attitude control based on the preprocessing result and then transmit the result to the corresponding bit-based satellite to perform the satellite attitude control.

On the other hand, the quantum-based satellite may transmit the multimodal data collected from the corresponding satellite to a nearby bit-based satellite to perform preprocessing. In this case, the bit-based satellite may transmit a preprocessing result to the quantum-based satellite. Then, the quantum-based satellite may estimate the result of satellite attitude control based on the received preprocessing result and perform its own satellite attitude control based on the estimated result.

That is, the bit-based satellite and the quantum-based satellite positioned near each other may cooperate with each other to perform satellite attitude control, but the bit-based satellite may be in charge of preprocessing multimodal data, and the quantum-based satellite may be in charge of estimating the satellite attitude control result using the preprocessing result.

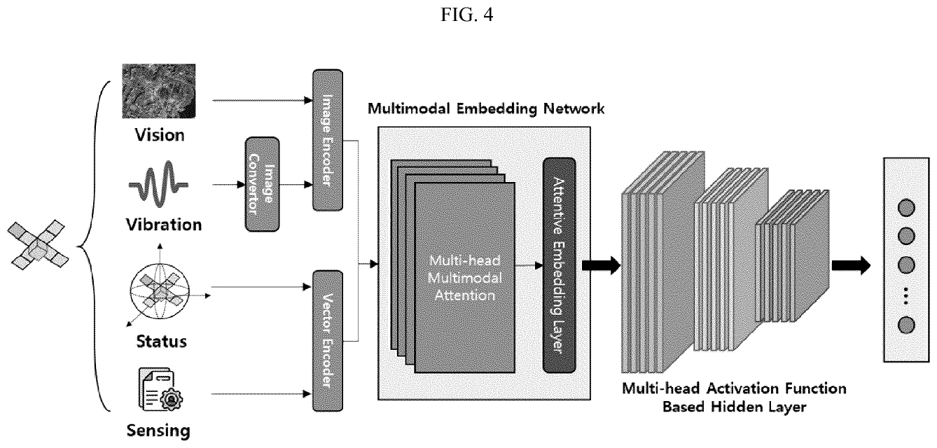

FIG. 4 is a diagram schematically illustrating a process of preprocessing multimodal data in the bit-based satellite according to an embodiment of the present disclosure.

Referring to FIGS. 3 and 4, image data 101 generated in the bit-based satellite may be input to an image encoder 107. In an embodiment, the image data 101 may be image data captured by an image capturing device (not illustrated) mounted on the bit-based satellite.

Vibration data 102 generated in the bit-based satellite may be converted through an image converter 106 and input to the image encoder 107. Here, the vibration data 102 may be data generated from a vibration sensor (not illustrated) mounted on the corresponding satellite. The image converter 106 may convert the vibration data 102 into an image format and transmit the converted vibration data to the image encoder 107.

Status data 103 and sensing data 104 generated in the bit-based satellite may each be input to a vector encoder 108. Here, the status data 103 is data on the attitude and status of the corresponding satellite, and may include, for example, the current time, the position of the corresponding satellite, the velocity of the corresponding satellite, and the angular velocity of the corresponding satellite.

The image encoder 107 may receive the image data 101 as input and generate a first image embedding. The image encoder 107 may receive the vibration data 102 in an image format as input and generate a second image embedding.

The vector encoder 108 may receive the status data 103 and generate a first vector embedding. The vector encoder 108 may receive the sensing data 104 as input and generate a second vector embedding.

Here, the first image embedding, the second image embedding, the first vector embedding, and the second vector embedding may each be input to a multimodal embedding synthesis network 109.

The multimodal embedding synthesis network 109 may include a multimodal multi-head attention module 110 and an attentive embedding layer 111. The multimodal multi-head attention module 110 may transform (that is, compress) a plurality of pieces of input data (that is, the first image embedding, the second image embedding, the first vector embedding, and the second vector embedding) into one representative vector. That is, the multimodal multi-head attention module 110 may transform the plurality of pieces of input data into one representative vector using the multi-head attention technique.

The attentive embedding layer 111 may receive the representative vector as input and generate a semantic emphasis embedding vector. That is, the attentive embedding layer 111 may generate a semantic emphasis embedding vector by performing processing that emphasizes an implicit meaning contained in the representative vector. For example, the attentive embedding layer 111 may generate the semantic emphasis embedding vector by performing processing such as normalization, linear transformation, residual combination, the like on the representative vector.

Here, the semantic emphasis embedding vector may be input to a multi-head activation function-based hidden layer 112. The multi-head activation function-based hidden layer 112 may extract a preprocessing result feature 113 from the input semantic emphasis embedding vector. In an embodiment, the multi-head activation function-based hidden layer 112 may extract the preprocessing result feature reflecting correlations between modalities by placing different activation function heads in parallel.

Hereinafter, a process of performing preprocessing in the bit-based network model 105 is described as follows.

Each piece of modal data m is transformed into Hm through an image encoder 107 and a vector encoder 108. Next, Hm is transformed into Query (Q), Key (K), and Value (V) by a projection parameter W in the multimodal multi-head attention module 110 as follows.

$${Q}_{i}^{m} = {H}^{m} {W}_{i}^{Q , m}$$

$${K}_{i}^{m} = {H}^{m} {W}_{i}^{K , m}$$

$${V}_{i}^{m} = {H}^{m} {W}_{i}^{V , m}$$

The above Q, K, and V may obtain a Head values as follows through the attention module.

$$\begin{matrix}Attn ( {Q}_{i}^{m} , {K}_{i}^{m} , {V}_{i}^{m} ) = σ ( \frac{{Q}_{i}^{m} {K}_{i}^{{m}^{T}}}{\sqrt{{d}_{k}^{m}}} ) {V}_{i}^{m} \\ {head}_{i}^{m} = Attn ( {Q}_{i}^{m} , {K}_{i}^{m} , {V}_{i}^{m} )\end{matrix}$$

Here, the representative vector

$${F}_{m}^{a}$$

according to the modal data m may be derived as follows.

$${F}_{m}^{a} = [ {head}_{1}^{m} ; … ; {head}_{h}^{m} ] {W}^{O , m}$$

Next, the attentive embedding layer 111 may generate a semantic emphasis embedding vector from the representative vector

$${F}_{m}^{a} .$$

A semantic emphasis embedding vector FG may be expressed as follows.

$${F}^{G} = [ {F}_{1}^{{G}^{a}} ; {F}_{2}^{{G}^{a}} ; … ; {F}_{M}^{{G}^{a}} ]$$

The multi-head activation function-based hidden layer 112 may extract the preprocessing result feature 113 using the semantic emphasis embedding vector FG as input. The preprocessing result feature 113 may be transmitted to the quantum-based network model 114.

Now, the operation of the quantum-based network model 114 will be described.

The quantum-based network model 114 may receive each of the preprocessing result feature 113 and a mission signal 115 as input. The mission signal 115 may include information on a mission of the bit-based satellite. Here, the mission of the satellite may include observation of stars, observation of the Earth, or the like, and in this case, the mission signal 115 may include information on latitude, longitude, and altitude of an observation target.

The preprocessing result feature 113 and the mission signal 115 may be input to an embedding circuit 116. The embedding circuit 116 may serve to convert the preprocessing result feature 113 and the mission signal 115, which are bit-based information, into quantum-based information. The embedding circuit 116 may receive the preprocessing result feature 113 and the mission signal 115 as input and output a quantum embedding.

The quantum embedding output from the embedding circuit 116 may be input to a parameterized quantum circuit (PQC) 117. The parameterized quantum circuit 117 may extract a quantum feature for satellite attitude control from the quantum embedding.

The quantum feature output from the parameterized quantum circuit 117 may be input to a decoder 118. The decoder 118 may convert the quantum feature into bit-based information and output a satellite attitude control result 119. The satellite attitude control result 119 may be transmitted to the bit-based satellite. The satellite attitude control result 119 may include information such as rotation about each axis of the bit-based satellite, engine output for the rotation, and the like.

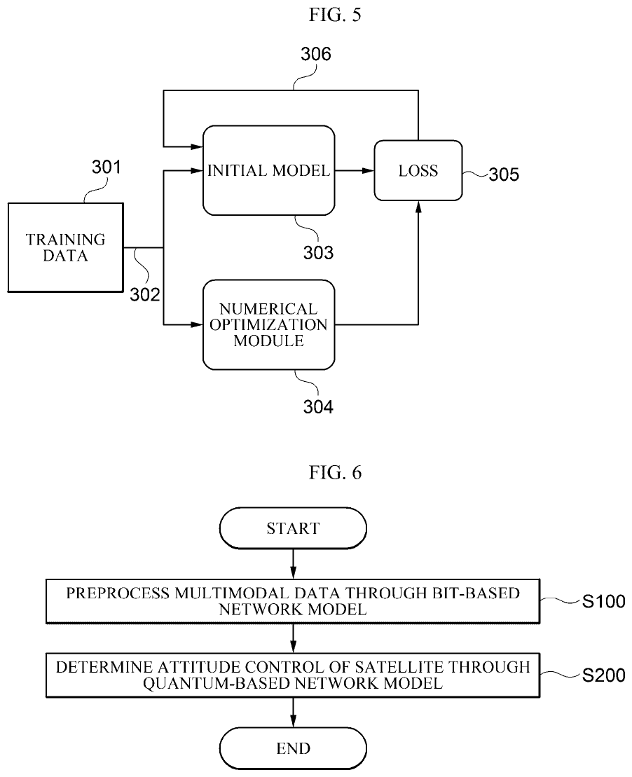

FIG. 5 is a diagram illustrating a state in which an initial model is generated in a central server according to an embodiment of the present disclosure.

Referring to FIG. 5, the central server (that is, a global server on the ground) may train an initial model 303 using pre-stored training data 301. The training data 301 may include multimodal data acquired from a satellite. The initial model 303 may include a bit-based network model and a quantum-based network model.

The training data 301 may be input (302) into each of the initial model 303 and a numerical optimization module 304. The initial model 303 may be trained to receive the training data 301 as input and output a satellite attitude control result. In this case, the bit-based network model of the initial model 303 may receive the training data 301 as input and output a preprocessing result feature, and the quantum-based network model may receive the preprocessing result feature and a mission signal as input and output a satellite attitude control result.

The numerical optimization module 304 may serve to assist in training the initial model 303. The numerical optimization module 304 may receive the training data 301 as input and output a reference value (a reference value for satellite attitude control result) based on numerical optimization. That is, since the training data 301 is not sufficient when the training of the initial model 303, the numerical optimization module 304 may be introduced to supplement the output result of the initial model 303 during training of the initial model 303.

The central server may train the initial model 330 based on a first loss function according to reinforcement learning that applies proximal policy optimization (PPO) to the initial model 330 and a second loss function using a reference value for satellite attitude control result. In this case, an overall loss function

$${L}_{n}^{TOTAL} ( ϕ )$$

for training the initial model 330 may be expressed by the equation below.

$${L}_{n}^{TOTAL} ( ϕ ) = {L}_{n}^{PPO} ( ϕ ) + ψ \cdot {L}_{n}^{CA} ( ϕ ) \qquad ( Equation )$$

$${L}_{n}^{PPO} ( ϕ \text{):}$$

First loss function

$${L}_{n}^{CA} ( ϕ \text{):}$$

Second loss function

ψ: Pre-set adjustment parameter

Here, the second loss function may be a cross-attention-based loss function that calculates a mean square error (MSE) between the output of the initial model 303 and the output of the numerical optimization module 304. The second loss function may be expressed by the equation below.

$${L}_{n}^{CA} ( ϕ ) = \frac{1}{{n}_{a}} {\sum }_{i = 1}^{{n}_{a}} {( {\overline{A}}_{n} ( i ) - {A}_{n} ( i ) )}^{2} \qquad ( Equation )$$

nₐ: Total number of elements considered in attention

Ãₙ(i): Satellite attitude control result output by the initial model

Aₙ(i): Reference value output by the numerical optimization module

FIG. 6 is a diagram briefly illustrating a process of performing satellite attitude control through knowledge cooperation between heterogeneous satellites in an embodiment of the present disclosure.

Referring to FIG. 6, multimodal data generated in a satellite is preprocessed through the bit-based network model 105 (S100).

Based on the data (a preprocessing result feature) preprocessed from the bit-based network model 105, the attitude control of the satellite is determined through the quantum-based network model 114 (S200).

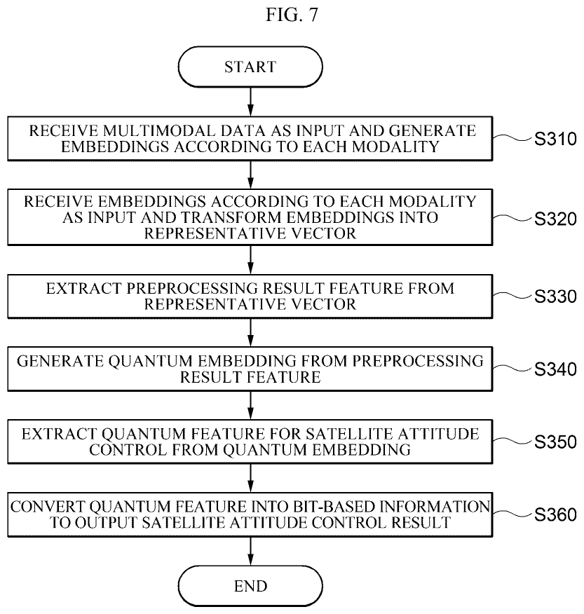

FIG. 7 is a flowchart specifically illustrating a process of performing satellite attitude control through knowledge cooperation between heterogeneous satellites in an embodiment of the present disclosure. In the illustrated flowchart, the method is divided into a plurality of steps; however, at least some of the steps may be performed in a different order, performed together in combination with other steps, omitted, performed in subdivided steps, or performed by adding one or more steps not illustrated.

Referring to FIG. 7, multimodal data including image data, vibration data, status data, and sensing data generated in a satellite (e.g., a bit-based satellite) may be received as input and embeddings according to each modality may be generated (S310). Here, the embeddings according to each modality may be a first image embedding, a second image embedding, a first vector embedding, and a second vector embedding.

Next, the embeddings according to each modality may be received as input and transformed into one representative vector (S320). Next, the representative vector may be received as input and a preprocessing result feature may be extracted (S330). In this case, a semantic emphasis embedding vector is generated by performing semantic emphasis processing on the representative vector, and then a preprocessing result feature may be extracted by processing the semantic emphasis embedding vector using a multi-head activation function.

Next, the preprocessing result feature may be transmitted to a quantum-based satellite adjacent to the satellite, and the quantum-based satellite may generate a quantum embedding from the preprocessing result feature (S340).

Next, a quantum feature for satellite attitude control may be extracted from the quantum embedding (S350), and the quantum feature may be converted into bit-based information to output a satellite attitude control result (S360).

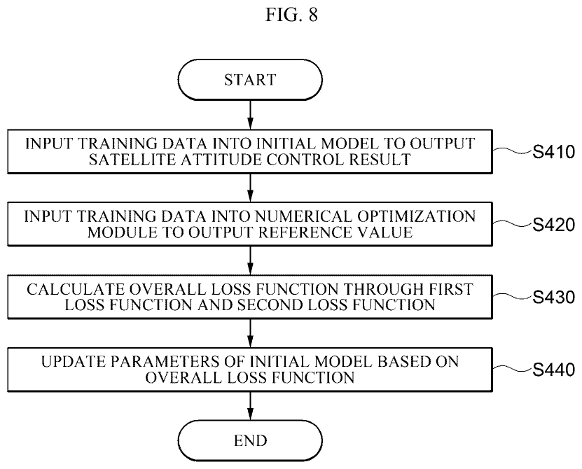

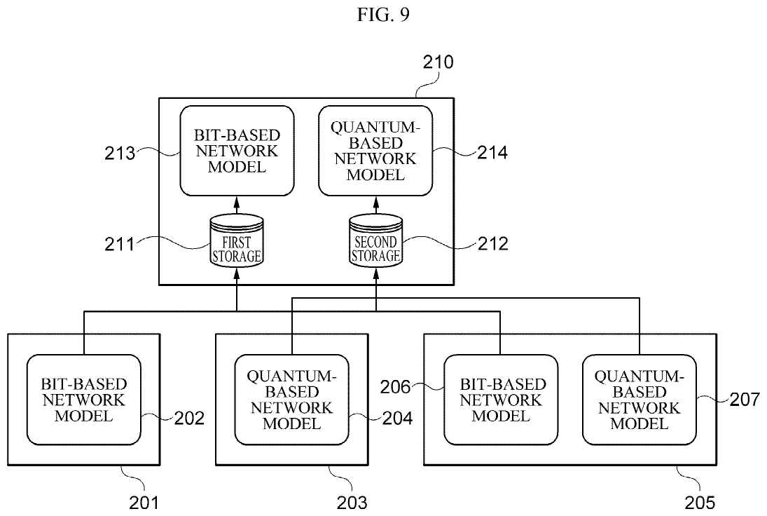

FIG. 8 is a flowchart for describing a process of training an initial model in an embodiment of the present disclosure. In the illustrated flowchart, the method is divided into a plurality of steps; however, at least some of the steps may be performed in a different order, performed together in combination with other steps, omitted, performed in subdivided steps, or performed by adding one or more steps not illustrated.

Referring to FIG. 8, training data may be input into the initial model to output a satellite attitude control result (S410).

Next, the training data may be input into the numerical optimization module to output a reference value for the satellite attitude control result (S420).

Next, an overall loss function may be calculated through a first loss function according to reinforcement learning to which proximal policy optimization (PPO) is applied and a second loss function using the reference value for the satellite attitude control result (S430).

Next, parameters of the initial model may be updated based on the calculated overall loss function (S440).

FIG. 9 is a diagram illustrating a state in which federated learning between each satellite and a central server is performed in an embodiment of the present disclosure.

Referring to FIG. 9, satellites may include a bit-based satellite 201, a quantum-based satellite 203, and a hybrid satellite 205. The bit-based satellite 201 may include a bit-based network model 202. A quantum-based satellite 203 may include a quantum-based network model 204. The hybrid satellite 205 may include both a bit-based network model 206 and a quantum-based network model 207.

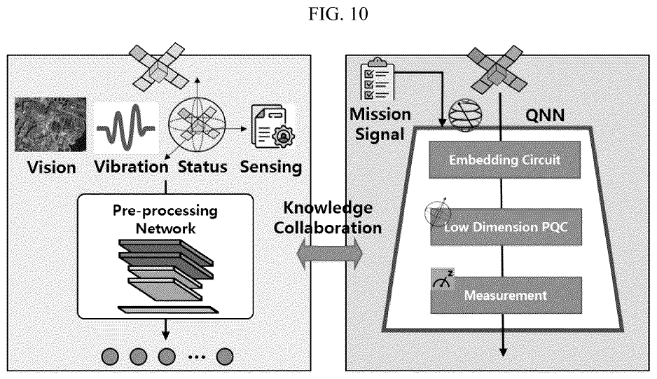

FIG. 10 is a diagram illustrating a state in which local learning is performed through knowledge collaboration between heterogeneous satellites in an embodiment of the present disclosure. The bit-based satellite 201, the quantum-based satellite 203, and the hybrid satellite 205 may perform local learning on their own network models through knowledge collaboration between adjacent heterogeneous satellites.

Here, the bit-based satellite 201 and the hybrid satellite 205 may transmit locally trained parameters of the bit-based network model 202 and the bit-based network model 206, respectively, to a central server 210. Then, the central server 210 may store the locally trained parameters of the bit-based network models 202 and 206 in a first storage 211.

In addition, the quantum-based satellite 203 and the hybrid satellite 205 may transmit locally trained parameters of the quantum-based network model 204 and the quantum-based network model 207, respectively, to the central server 210. Then, the central server 210 may store the locally trained parameters of the quantum-based network models 204 and 207 in a second storage 212.

The central server 210 may update parameters of a bit-based network model 213 (that is, a bit-based global model) by averaging the locally trained parameters of the bit-based network models 202 and 206 stored in the first storage 211.

The central server 210 may update parameters of a quantum-based network model 214 (that is, a quantum-based global model) by averaging the locally trained parameters of the quantum-based network models 204 and 207 stored in the second storage 212.

The central server 210 may transmit the updated parameters of the bit-based global model to each of the bit-based satellite 201 and the hybrid satellite 205. Then, the bit-based satellite 201 and the hybrid satellite 205 may update the parameters of the bit-based network model 202 and the bit-based network model 206, respectively, with the updated parameters of the bit-based global model.

The central server 210 may transmit the updated parameters of the quantum-based global model to each of the quantum-based satellite 203 and the hybrid satellite 205. Then, the quantum-based satellite 203 and the hybrid satellite 205 may update the parameters of the quantum-based network model 204 and the quantum-based network model 207, respectively, with the updated parameters of the quantum-based global model.

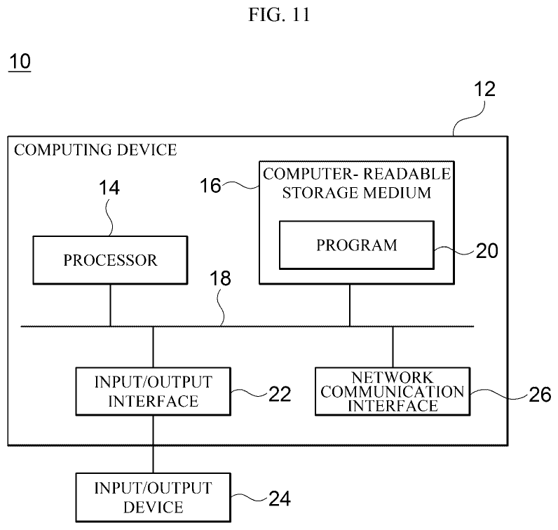

FIG. 11 is a block diagram exemplarily illustrating a computing environment 10 that includes a computing device suitable for use in exemplary embodiments. In the illustrated embodiment, each component may have a different function and capability in addition to those described below, and additional components may be included in addition to those described below.

An illustrated computing environment 10 includes a computing device 12. In an embodiment, the computing device 12 may be a bit-based satellite. In addition, the computing device 12 may be a quantum-based satellite. In addition, the computing device 12 may be a hybrid satellite. In addition, the computing device 12 may be a central server.

The computing device 12 includes at least one processor 14, a computer-readable storage medium 16, and a communication bus 18. The processor 14 may cause the computing device 12 to operate according to the above-described exemplary embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the exemplary embodiments.

The computer-readable storage medium 16 is configured to store computer-executable instructions or program codes, program data, and/or other suitable forms of information. A program 20 stored in the computer-readable storage medium 16 includes a set of instructions executable by the processor 14. In an embodiment, the computer-readable storage medium 16 may be a memory (a volatile memory such as a random-access memory, a non-volatile memory, or any suitable combination thereof), one or more magnetic disk storage devices, optical disc storage devices, flash memory devices, other types of storage media that are accessible by the computing device 12 and may store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The network communication interface 26 may communicate with adjacent satellites or the central server.

The input/output device 24 may be connected to other components of the computing device 12 via the input/output interface 22. The exemplary input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, an interlocutor, and/or a network card. The exemplary input/output device 24 may be included inside the computing device 12 as one of components constituting the computing device 12, or may be connected to the computing device 12 as a separate device distinct from the computing device 12.

According to disclosed embodiments, there is an effect that the present disclosure can be applied and utilized as an attitude control technology not only in learning in space but also in extreme environments where the use of artificial intelligence is restricted through attitude control of an artificial satellite.

In addition, since precise geographical position information can be provided, there is an effect in that the present disclosure can improve the efficiency of resource exploration and geographic information acquisition and enhance the safety of air traffic, maritime logistics, and land transportation.

Although the representative embodiments of the present disclosure have been described in detail as above, those skilled in the art will understand that various modifications may be made thereto without departing from the scope of the present disclosure. Therefore, the scope of rights of the present disclosure should not be limited to the described embodiments, but should be defined not only by the claims set forth below but also by equivalents of the claims.

What is claimed is:

1. A learning system comprising:
satellites; and
a central server configured to communicate with the satellites,
wherein the satellites include two or more of a bit-based satellite, a quantum-based satellite, and a hybrid satellite, and
the central server trains initial models including a bit-based network model and a quantum-based network model using training data, distributes the bit-based network model among the trained initial models to each of the bit-based satellite and the hybrid satellite, and distributes the quantum-based network model among the trained initial models to each of the quantum-based satellite and the hybrid satellite.

2. The learning system of claim 1, wherein the training data is multimodal data acquired from the satellites, and
the central server trains the initial models such that the bit-based network model of the initial models receives the training data as input and outputs a preprocessing result feature, and the preprocessing result feature and a preset mission signal are input into the quantum-based network model of the initial models to output a satellite attitude control result.

3. The learning system of claim 1, wherein the central server trains the initial model such that the training data is input into the initial model to output a satellite attitude control result, the training data is input into a numerical optimization module to output a reference value for the satellite attitude control result, and a difference between the satellite attitude control result of the initial model and the reference value of the numerical optimization module is minimized.

4. The learning system of claim 1, wherein the bit-based satellite and the hybrid satellite each locally train the distributed bit-based network model and transmit parameters of the locally trained bit-based network model to the central server, and
the central server updates parameters of the bit-based network model of the initial models by averaging the parameters of the locally trained bit-based network model.

5. The learning system of claim 1, wherein the quantum-based satellite and the hybrid satellite each locally train the distributed quantum-based network model and transmit parameters of the locally trained quantum-based network model to the central server, and
the central server updates parameters of the quantum-based network model of the initial models by averaging the parameters of the locally trained quantum-based network model.

6. The learning system of claim 1, wherein the bit-based satellite inputs multimodal data generated in the bit-based satellite into the distributed bit-based network model to extract a preprocessing result feature, transmits the extracted preprocessing result feature from the bit-based satellite to an adjacent quantum-based satellite or hybrid satellite, and receives a satellite attitude control result from the adjacent quantum-based satellite or hybrid satellite to perform satellite attitude control.

7. The learning system of claim 1, wherein the quantum-based satellite receives a preprocessing result feature from an adjacent bit-based satellite, inputs the received preprocessing result feature into the distributed quantum-based network model to output a satellite attitude control result, and transmits the satellite attitude control result to the adjacent bit-based satellite.

8. The learning system of claim 1, wherein the quantum-based satellite transmits multimodal data generated in the quantum-based satellite from the quantum-based satellite to an adjacent bit-based satellite or hybrid satellite, receives a preprocessing result feature for the multimodal data from the adjacent bit-based satellite or hybrid satellite, inputs the received preprocessing result feature into the distributed quantum-based network model to output a satellite attitude control result, and performs satellite attitude control based on the output satellite attitude control result.

9. The learning system of claim 1, wherein the hybrid satellite inputs multimodal data generated in the hybrid satellite into the distributed bit-based network model to extract a preprocessing result feature, inputs the extracted preprocessing result feature into the distributed quantum-based network model to output a satellite attitude control result, and performs satellite attitude control based on the output satellite attitude control result.

10. A method performed in a satellite having one or more processors and a memory storing one or more programs executed by the one or more processors, the method comprising:
receiving a pre-trained bit-based network model distributed from a central server;
inputting multimodal data generated in the satellite into the distributed bit-based network model to extract a preprocessing result feature;
transmitting the extracted preprocessing result feature from the satellite to an adjacent quantum-based satellite or hybrid satellite; and
receiving a satellite attitude control result from the adjacent quantum-based satellite or hybrid satellite and performing satellite attitude control.

11. The method of claim 10, wherein the multimodal data includes image data, vibration data, status data, and sensing data, and
the extracting of the preprocessing result feature includes:
inputting the image data into an image encoder to generate a first image embedding;
inputting the vibration data into an image converter to convert the vibration data into an image format, and inputting the vibration data in the image format into an image encoder to generate a second image embedding;
inputting the status data into a vector encoder to generate a first vector embedding;
inputting the sensing data into the vector encoder to generate a second vector embedding;
inputting the first image embedding, the second image embedding, the first vector embedding, and the second vector embedding into a multimodal multi-head attention module to transform the first image embedding, the second image embedding, the first vector embedding, and the second vector embedding into one representative vector;
inputting the representative vector into an attentive embedding layer to generate a semantic emphasis embedding vector; and
inputting the semantic emphasis embedding vector into a multi-head activation function-based hidden layer to extract the preprocessing result feature.

12. A method performed in a satellite having one or more processors and a memory storing one or more programs executed by the one or more processors, the method comprising:
receiving a pre-trained quantum-based network model distributed from a central server;
transmitting multimodal data generated in the satellite to a bit-based satellite or a hybrid satellite adjacent to the satellite;
receiving a preprocessing result feature for the multimodal data from the adjacent bit-based satellite or hybrid satellite; and
inputting the preprocessing result feature into the distributed quantum-based network model to output a satellite attitude control result, and performing satellite attitude control based on the output satellite attitude control result.
